(19) United States
(12) Patent Application Publication
(10) Pub. No.: US 2025/0368277 A1
(43) Pub. Date: Dec. 4, 2025

(54) Bus For Transporting Passengers

(71) Applicant: Carrosserie Hess AG, Bellach (CH)

(72) Inventors: Alex Naef, Bellach (CH); Jan Wunderlich, Balsthal (CH)

(73) Assignee: Carrosserie Hess AG, Bellach (CH)

(21) Appl. No.: 19/222,533

(22) Filed: May 29, 2025

(30) Foreign Application Priority Data
Jun. 3, 2024 (EP) 24179662.2

(51) Int. Cl. B62D 31/02; B60R 13/08

(52) U.S. Cl. CPC B62D 31/025; B60R 13/0815

(57) ABSTRACT

A bus for transporting passengers includes a body which surrounds a passenger compartment, wherein the body includes a metallic framework structure and planar elements fastened thereto, and wherein the passenger compartment is thermally insulated from an exterior by an insulation system arranged on the metallic framework structure. The insulation system includes multiple-glazed side windows mounted on the metallic framework structure as first planar elements and second planar elements mounted on the metallic framework structure, which are provided at least on one main surface with a first insulation layer made of a melamine-based foam material and with a second insulation layer made of an aerogel material. A good ratio between insulation properties, weight and costs can be achieved by this combination of planar elements.

### FIELD OF THE INVENTION

The invention relates to a bus for transporting passengers, comprising a body which surrounds a passenger compartment, wherein the body comprises a metallic framework structure and planar elements fastened thereto, and wherein the passenger compartment is thermally insulated from an exterior by an insulation system arranged on the metallic framework structure.

### BACKGROUND OF THE INVENTION

Buses of various types are used for transporting passengers, firstly as so-called coaches, which are constructed exclusively for transporting seated passengers and are often used in long-distance transport, in particular in charter operation. Secondly, various types of buses are used in public passenger transport, for example city buses or overhead line buses (also referred to as trolley buses). In the present case, vehicles are generally referred to as buses if they serve primarily for transporting passengers, can transport more than 9 persons and have a length of more than 5 m. Buses comprise in particular so-called midi buses with a length of approximately 8-11 m, solo buses or coaches with a length of approximately 10-15 m, articulated buses with a length of approximately 16.5-20 m and double-articulated buses with a length of up to 25 m.

Buses are conventionally often driven by diesel engines. In recent years, especially hybrid buses and pure electric buses have become more prevalent after gas-operated buses. Such buses carry a battery or a plurality of batteries for energy storage.

As a result of the electrification of the drive, the normally freely available waste heat of the internal combustion engine is missing. In principle, electric buses have to be heated electrically, which can significantly reduce their range in heating-intensive periods. Since in cold weather conditions the usable capacity of the battery gets smaller, the battery has to be dimensioned larger, which overall leads to a higher energy requirement, or a diesel heater has to be used for support, which is undesirable in particular on account of the associated emissions.

Various approaches for reducing the energy required for heating the passenger compartment are known, for example the use of heat pumps, the use of infrared heaters, demand-optimized heater controls, etc.

However, an important approach is also an improvement in the thermal insulation of the passenger compartment, with the result that less heat is emitted to the surroundings. In the case of conventional buses, the thermal insulation was often considered as a secondary issue since, on account of the diesel engine, sufficient waste heat was available in any case for heating the passenger compartment. The main focus in the design of the body has hitherto been weight reduction. The bodies were made of aluminum, plastic, steel or also partially composite materials. The installed materials have a heat transmission coefficient in the range from approximately 200 W/m² K (aluminum) to approximately 0.2 W/m² K. By contrast, modern available insulation materials have significantly lower heat transmission coefficients in ranges from 0.025 to 0.05 W/m² K.

Nevertheless, the insulation cannot simply be maximized since, on the one hand, this leads to higher costs and to a higher weight (and therefore an increased energy requirement for the drive) and, on the other hand, this can reduce the volume of the usable interior.

### BRIEF SUMMARY OF THE INVENTION

An aspect of the invention may provide a bus for transporting passengers which belongs to the technical area mentioned at the outset and which has improved thermal insulation and at the same time is economical and energy-saving.

According to an embodiment of the invention, the insulation system comprises
a) multiple-glazed side windows mounted on the metallic framework structure as first planar elements; and
b) second planar elements mounted on the metallic framework structure, which are provided at least on one main surface with a first insulation layer made of a melamine-based foam material and with a second insulation layer made of an aerogel material.

The side windows therefore have two or more glass panes, double glazing being preferred on account of the ratio of weight and insulation properties.

The aerogel material is a highly porous solid body, the volume of which generally comprises more than 90% of air-filled pores, the proportion of air in the total volume often being 98% or more. In particular, aerogels based on silicate are commercially available and can be used within the scope of the present invention.

The solution is suitable for buses having a metallic framework structure and planar elements fastened thereto, for example for buses which are based on the CO-BOLT® system from the applicant. This system comprises extruded aluminum profiles with C-shaped channels which are connected by means of corresponding corner pieces and clamping plates by means of screw connections. The self-supporting body consists of two large main profiles, a roof frame profile and a side wall profile, which are connected by a series of smaller profiles. The upper part of the body is formed completely by these profiles and does not require any further panelling. Simple side flaps which can be replaced quickly in the event of damage cover the entire length of the lower part of the body. The front and rear are formed from glass-fiber-reinforced polyester moldings or moldings made of another suitable plastic. However, the invention can also be used in other framework bodies, for example on the basis of welded steel profiles or profiles made of composite materials.

The invention can be used in all the bus types mentioned, that is to say in particular for midi buses, solo buses, articulated buses and double-articulated buses, both for travel operations and for operations in public transport. The invention can also be applied to bus trains, that is to say solo buses with a passenger trailer, wherein both the body of the towing vehicle and that of the trailer can be designed according to the invention. Accordingly, a passenger trailer is also understood as a “bus” within the meaning of the present application.

A good ratio between insulation properties, weight and costs can be achieved by the combination of multiple-glazed windows as first planar elements with second planar elements which are insulated by a melamine foam layer and an aerogel layer according to the invention. The combination is suitable in particular for insulating buses, in particular electrically driven buses, and permits energy savings, in particular in cold weather conditions. Since, conversely, in hot weather conditions, the passenger compartment heats up less on account of the insulation, the cooling capacity can be reduced, with the result that energy-efficient operation is possible even in such conditions.

The first insulation layer preferably has a first thickness of 20-50 mm, and the second insulation layer has a second thickness of 5-20 mm. In this case, preferably the first thickness is at least twice as large as the second thickness. A good ratio between insulation properties, volume and costs is achieved by such a combination of the thicknesses of the melamine foam layer and the aerogel layer. The first thickness is particularly preferably 30-40 mm, and the second thickness is 8-15 mm. The sequence of the layers, starting from the planar element, can be selected differently. Furthermore, further layers can be present, for example vapor barriers, adhesive layers or covers.

The side windows preferably have a noble gas filling and are provided with a low-E coating. Both these measures improve the thermal properties both in cooling operation and in heating operation, without noticeably increasing the total weight. Noble gas fillings and low-E coatings are known in particular from the field of housing and can also be implemented in an analogous manner in the case of the side windows of the bus according to the invention.

Preferably at least 20% of an outer surface of the body is provided with glazing. The outer surface in this case comprises both the sides, front and rear surfaces as well as the floor and the roof. In addition to the side windows according to the invention, the glazing in this case also encloses the windshield and rear windows. Preferably at least 80% of the glazing is formed by the side windows according to the invention. Advantageous insulation properties of the body are thereby achieved on account of the good thermal insulation thereof.

In preferred embodiments of the bus according to the invention, the side windows comprise an outer pane and at least one inner pane connected mechanically and sealingly to the outer pane, wherein an area of the outer pane is larger than an area of the inner pane. In particular, the area of the outer pane is at least 5% larger than that of the inner pane. Particularly advantageous insulation properties on the vehicle sides can therefore be achieved. Such a geometry can also have advantages in the retrofitting of existing buses.

In particular, in a lower region of the side windows, the outer pane extends downwards over the at least one inner pane, and an inner side of the outer pane is adhesively bonded to an outer surface of a substantially horizontally extending central chord of the metallic framework structure. The outer pane particularly preferably extends in the vertical direction completely over the vertical extent of the central chord. The central chord composed of the metal of the framework structure is therefore already covered towards the outside by the outer pane, and no additional cover is required in this region. Furthermore, the arrangement can thus already be insulated well on the outer side of the central chord. Since the lower region of the outer pane serves as a cover and in particular does not have to be transparent or light-transmissive, it can be colored or provided with an opaque coating.

Furthermore, an inner side, facing the passenger compartment, of the central chord is advantageously provided with a layer of an aerogel material, and a cladding profile is mechanically fastened to the central chord, such that the cladding profile partially engages over the layer and, on an outer side, abuts areally against the inner pane of at least one of the side windows, that is to say extends with an outer portion parallel to the inner pane, which makes it possible, for example, to produce a joint between the cladding profile and the side window. This ensures good thermal insulation on the inner side of the central chord and at the transition to the side windows.

A layer of an insulation material, in particular of a rubber material, is advantageously arranged on the metallic framework structure at least in regions on a side facing the passenger compartment and/or on a side facing an opening formed by the framework structure. This prevents the metallic elements of the framework structure from forming cold bridges. The insulation material preferably is a synthetic rubber material in a closed-cell material strip. This material strip is preferably adhesively bonded directly to the corresponding surface of the structural element. The layer thickness of the insulation material is in particular 2-5 mm. An arrangement on the side facing the opening is particularly expedient if the opening is lined with a second planar element. In addition to the insulation material, further layers can be present, for example an adhesive layer, a vapor barrier or the like.

The body preferably comprises a floor which comprises a base plate made of a composite product of crosslinked polymer foam and glass fibres as well as a floor covering applied on the inside.

The crosslinked polymer foam of the base plate is based in particular on polyurethane and is a closed-cell foam. The thickness of the base plate is preferably 12-25 mm.

The floor covering comprises in particular a support layer, decorative and wear layers arranged thereabove as well as a backing arranged therebehind and a rear side, for example made of a textile material, as is known in the art. For example, the support layer may be formed by a glass-fibre mesh.

The floor covering preferably comprises a foamed layer on the rear side of the support layer for further improvement of the thermal insulation.

The described composition of the floor permits good thermal insulation in the floor region which at the same time has a high mechanical load-bearing capacity.

The body advantageously comprises a roof which includes second planar elements which are arranged in openings of the metallic framework structure. These permit a flat construction of the roof. Towards the outside, the framework structure in the roof region is covered in particular by a roof skin, for example composed of a glass-fibre composite material, while it is covered on the inner side by a cladding. The framework structure is advantageously provided on the sides facing the openings with the abovementioned rubber layer in order to interrupt cold bridges.

The body preferably comprises a layer of an aerogel material in the region of wheel arches. The layer has a thickness of 5-15 mm, for example. As a rule, an attachment in certain regions is sufficient to substantially reduce the heat loss in this region.

The layer of the aerogel material is preferably arranged in the region of the wheel arches on an outer side, facing away from the passenger compartment, of the body, and a mechanical protective layer is arranged on the outside of the insulation layer. The mechanical protective layer is formed, for example, by a cladding, for example a plate composed of a robust plastic or composite material or of stainless steel.

At least one door of the bus is advantageously provided with a device for generating an air curtain. All doors for use by the passengers are particularly preferably provided with such a device. Such a device comprises an air outlet for delivering (optionally temperature-controlled) air, which air outlet is arranged in particular above the door. It further preferably comprises an air inlet on the opposite side of the door (that is to say in particular at the bottom). The air outlet and optionally the air inlet are connected to a fan for conveying the air required for the air curtain. In cold weather conditions, the air curtain reduces the heat loss when the door is open. In the case of warm outside temperatures, it can be used to reduce the heat transfer from the outside into the interior.

In preferred embodiments, the bus comprises an electric drive and a drive battery, wherein a charging connector for charging the drive battery is arranged in the region of the side windows in such a way that the charging connector is accessible from the outside through a cutout in one of the side windows. This construction permits an aesthetic and practical solution with optimum integration into the thermal insulation concept.

The cutout is arranged in particular in that region into which only the outer pane of the corresponding side window extends. The thermal insulation is achieved in particular by virtue of the fact that a receiving space is provided for the charging socket which forms the charging connector, and by virtue of the fact that this receiving space is closed off with respect to the passenger compartment, and therefore the function of the pane insulation is changed only to a minimal extent.

Further advantageous embodiments and combinations of features of the invention may be derived from the following detailed description and the entirety of the claims.

### BRIEF DESCRIPTION OF THE DRAWINGS

The drawings used to explain the exemplary embodiment show:

FIG. 1A, B two oblique images of the metallic framework structure of the body of a bus according to the invention with attached elements of the insulation system;

FIG. 2 a sectional view of the body in a rear region of the bus;

FIG. 3 an outside view of the rear, with windows inserted;

FIG. 4 a detailed view of the transition between central chord and side window; and

FIG. 5 a detailed view of a charging connection.

In principle, identical parts are provided with identical reference numerals in the figures.

### DETAILED DESCRIPTION

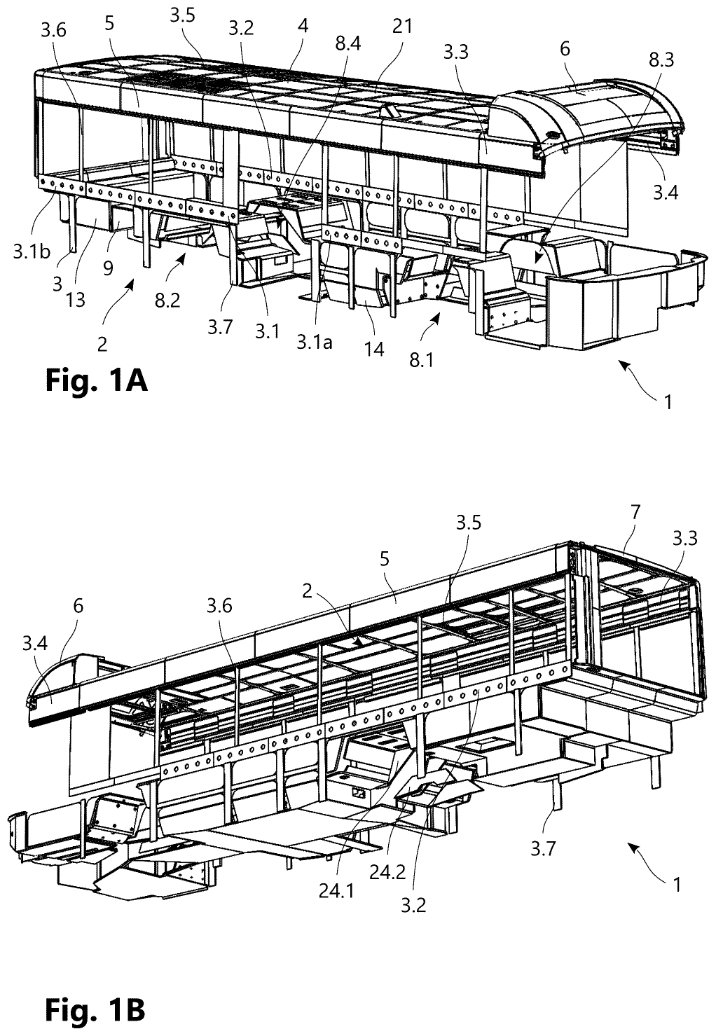

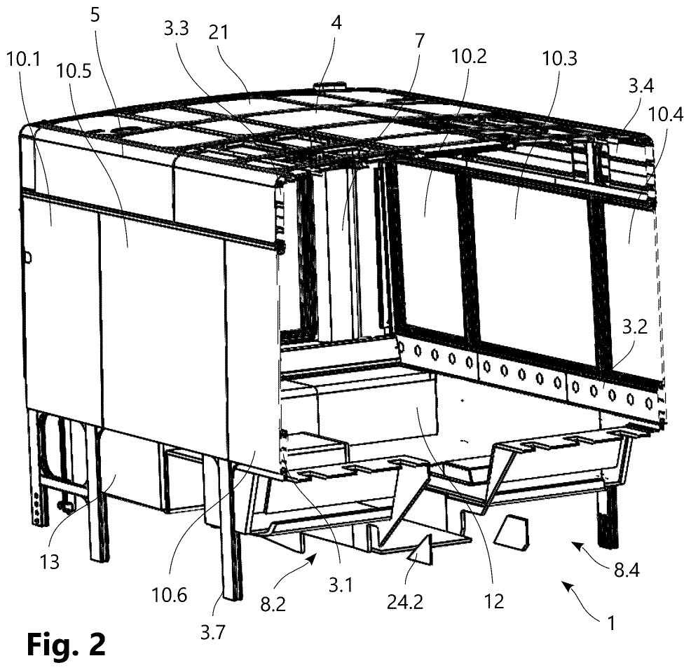

FIGS. 1A, 1B are two oblique images of the metallic framework structure of the body of a bus according to the invention with attached elements of the insulation system. FIG. 1A shows a view obliquely from the front to the right, while FIG. 1B shows a view from the rear left bottom. FIG. 2 shows a sectional view of the body in a rear part of the bus.

The body 1 of the solo bus shown here with a length of 10.7 m is based on a self-supporting framework structure 2 made of aluminium profiles 3. These are designed according to the CO-BOLT® system from the applicant. They have C-shaped channels with a predetermined geometry which enable a screw connection of a plurality of profiles with the aid of corner pieces and clamping plates. The framework structure 2 comprises two horizontally laterally running central chords 3.1, 3.2, wherein the central chord 3.1 is interrupted on the right-hand vehicle side in the region of a door opening, such that a front section 3.1a and a rear section 3.1b are formed. The framework structure furthermore comprises a roof frame 4 with lateral longitudinal profiles 3.3, 3.4 which run horizontally parallel above the central chords 3.1, 3.2, and roof profiles 3.5 which form a lattice structure which connects the two longitudinal profiles 3.3, 3.4. Vertical upper side profiles 3.6 run between the central chords 3.1, 3.2 and the respective longitudinal profile 3.3, 3.4 of the roof frame 4, in the extension thereof, starting from the central chord 3.1, 3.2, downward lower side profiles 3.7.

The body 1 furthermore comprises various areal cladding elements 5 which are only partially illustrated here. They have no load-bearing function and can therefore be designed with a small wall thickness and can be fastened simply to the framework structure 2. Where cladding elements 5 are relevant for the insulation structure of the illustrated embodiment, they are described in more detail further below. Arranged at the front end of the roof frame 4 is a roof hood 6 which is open downward, toward the interior of the body 1, and thus increases the clear height in the foremost region. Furthermore, a rear frame 7 is arranged in the rear region. Both the roof hood 6 and the rear frame 7 are glass-fiber-reinforced polyester moldings.

The upper part of the body is formed completely by these profiles and does not require any further panelling. Simple side flaps which can be replaced quickly in the event of damage cover the entire length of the lower part of the body. The front and rear are formed from glass-fiber-reinforced polyester moldings.

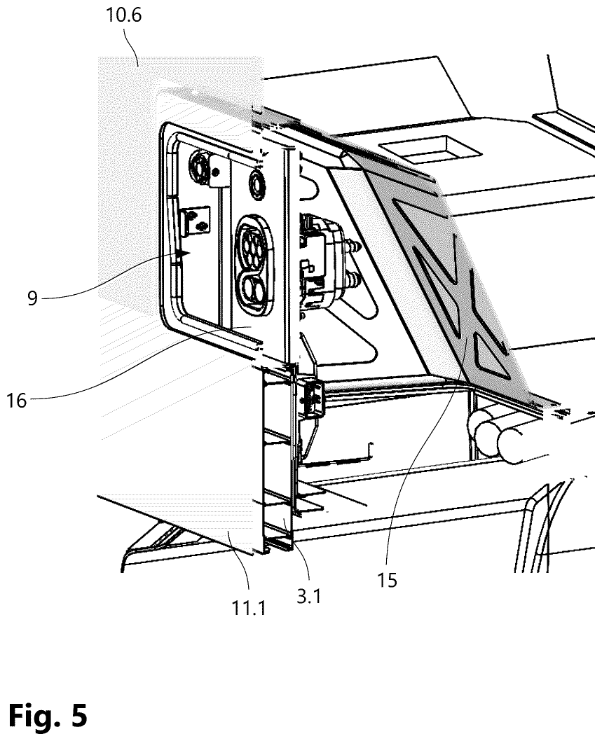

Furthermore, FIGS. 1A, 1B show, inter alia, the wheel housings 8.1, 8.2, 8.3, 8.4 and a recess 9 on the right-hand vehicle side, behind the rear wheel housing 8.2, for a charging connection. This is described in more detail further below, in conjunction with FIG. 5.

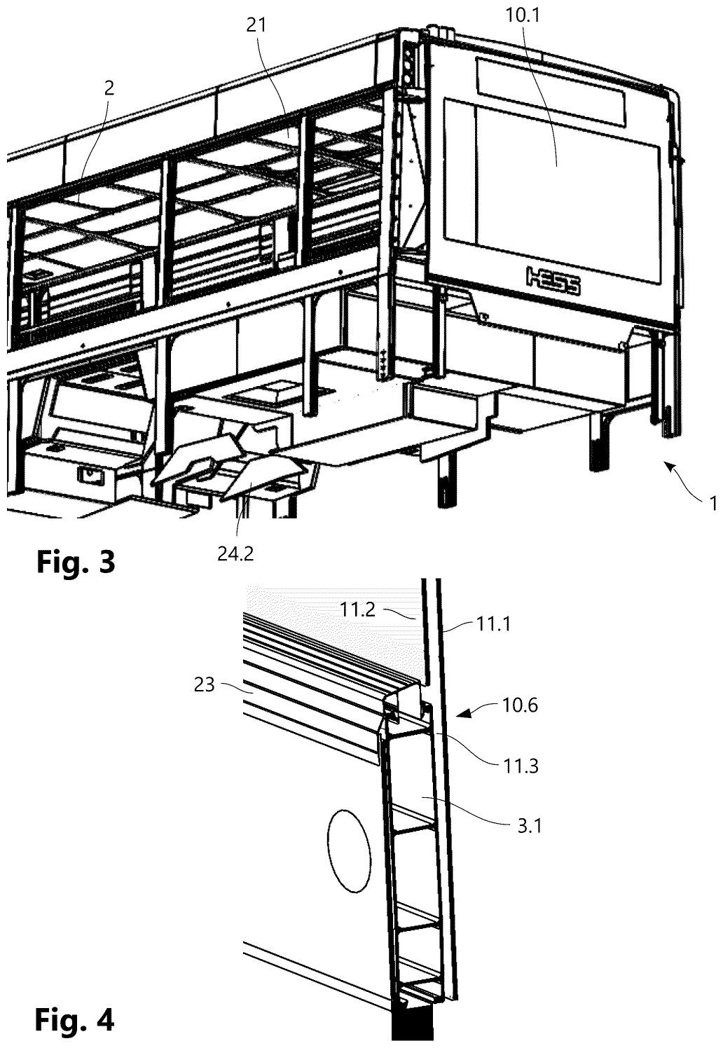

FIG. 3 shows an outside view of the rear of the body 1, with windows inserted. The figure shows, on the one hand, the rear window 10.1, on the other hand, a plurality of side windows 10.2, 10.3, 10.4 on the left-hand vehicle side, adjoining the vehicle rear, and side windows 10.5, 10.6 on the right-hand vehicle side, adjoining the vehicle rear. The windows are adhesively bonded to the load-bearing framework structure 2 of the body 1.

FIG. 3 shows a detailed view of the transition between central chord and side window. The construction of the side windows is also clearly apparent from this figure. The illustrated side window 10.6 comprises an outer pane 11.1 and an inner pane 11.2. These are held together—in a manner known per se—along the edge of the inner pane 11.2 with an edge composite 11.3. The edge composite seals off the interior between the two panes 11.1, 11.2 in a gas-tight manner. This interior contains a filling composed of krypton. Furthermore, a low-E coating is applied to the outwardly directed side of the inner pane 11.2. The outer pane 11.1 extends in its lower region beyond the area of the inner pane 11.2 and therefore beyond the edge composite 11.3. In the corresponding region, the outer pane 11.1 is provided with an opaque coating and, on its inner side, is adhesively bonded to the central chord 3.1.

The measures for thermal insulation which were taken in the illustrated exemplary embodiment are described below.

A 3 mm thick layer of synthetic rubber is adhesively bonded to the aluminium profiles 3 of the framework structure 2 in regions on the side facing the interior of the body 1 or on a side which faces the enclosed opening in the framework structure 2. Cold bridges between the outer side and the inner side of the body 1 are therefore interrupted.

The rubber layer is applied in particular to the side surfaces of the roof profiles 3.5 facing the openings between the roof frame 4. These openings are in turn provided with insulation elements 21 which comprise an outer (upper) layer of 10 mm foamed silicate aerogel on a polyurethane support and an inner (lower) layer of 30 mm open-cell melamine foam. Similarly, the inner side of the roof hood 6 is also lined with insulation from an outer (upper) layer of 10 mm foamed silicate aerogel on a polyurethane support and an inner (lower) layer of 40 mm open-cell melamine foam.

Insulation made of a 5 mm thick silicate aerogel layer is applied to the longitudinal profiles 3.3, 3.4 of the roof frame 4 on the outside substantially over the entire area, and likewise to the inner side of the longitudinal profiles 3.3, 3.4 in a lower connection region and to the inner side of the vertical upper side profiles 3.6 and to side plates in the height region of the windows. The vertical lower side profiles 3.7 are lined on their outer side with a layer of 10 mm foamed silicate aerogel.

The rear region, including rear frame 7 and platform 12, is lined on the inside and outside in each case with a layer of 20 mm foamed silicate aerogel on a polyurethane support. The wall 13 to the side of the platform 12 is lined, like other side wall elements, for example the wall 14 in the region of the front part of the wagon, on the outside with a layer of 30 mm of the foamed silicate aerogel on the polyurethane support.

A 2 mm thick aerogel layer 22 is adhesively bonded over the entire area to the inner side of the central chords 3.1, 3.2. This is engaged over in the region of its upper edge by a cladding profile 23. This borders on its outer side on the inner pane 11.2 of the side window 10.6 (cf. FIG. 4). In an analogous manner, a cladding profile is also arranged in the upper region of the side windows: it engages over with its inner, upper limb the lower connection region of the corresponding longitudinal profile with the silicate aerogel layer arranged thereon and runs with its outer, lower limb parallel to the upper edge of the inner pane.

The wheel housings 8.1.4 are lined in an upper region on their outer side facing the wheel in an upper region with a 20 mm thick layer 24.1 of aerogel, and in a lower region with a 10 mm thick layer 24.2 (cf. FIG. 1B). A stainless steel cover (not illustrated here) is arranged on these layers and protects these from mechanical influences.

In the region of the front of the body 1, the front apron and side wall surfaces are lined on the inside with a 10 mm thick aerogel layer.

Further insulating measures relate to the floor. This comprises a 17 mm thick plate made of a composite material with a closed-cell polyurethane foam and an embedded glass-fibre mesh. A floor covering with a thickness of approximately 6 mm is adhesively bonded to this plate and is based on a glass-fibre mesh as support layer. A decorative and wear layer are arranged on the upper side of the support layer, a backing and a 4 mm thick foamed layer for sound insulation and thermal insulation are arranged on the rear side.

FIG. 5 is a detailed view of a charging connection. This is accessible through the said cutout 9 in the right-hand side wall of the body 1. The cutout is located firstly in the outer pane 11.1 of the side window 10.6 and secondly in the central chord 3.1. Toward the rear, the receiving space formed behind the cutout 9 is closed off by a rear wall 15 made of sheet steel.

A charging socket 16, the connection of which is accessible from the outside through the cutout 9, is placed in the receiving space.

A heat transmission coefficient (U value) of less than 2 W/m² K can be achieved for the composition by means of the measures described. This is significantly lower than in standard insulated bus bodies which generally have a U value of approximately 3 W/m² K.

The invention is not restricted to the illustrated exemplary embodiment. Therefore, a plurality of the described measures for insulation can be combined in another way within the scope of the invention. As mentioned above, the vehicle can have devices for generating an air curtain in the doors. The geometry and arrangement of the insulation elements can likewise be varied.

In summary, it can be stated that the invention provides a bus for transporting passengers which has improved thermal insulation and at the same time is economical and energy-saving.

1. A bus for transporting passengers, comprising a body which surrounds a passenger compartment, wherein the body comprises a metallic framework structure and planar elements fastened thereto, and wherein the passenger compartment is thermally insulated from an exterior by an insulation system arranged on the metallic framework structure, the insulation system comprising:
a) multiple-glazed side windows mounted on the metallic framework structure as first planar elements; and
b) second planar elements mounted on the metallic framework structure, the second planar elements comprising at least on one main surface a first insulation layer made of a melamine-based foam material and a second insulation layer made of an aerogel material.

2. The bus according to claim 1, wherein the first insulation layer has a first thickness of 20-50 mm, and wherein the second insulation layer has a second thickness of 5-20 mm, and wherein the first thickness is at least twice as large as the second thickness.

3. The bus according to claim 1, wherein the side windows have a noble gas filling and comprise a low-E coating.

4. The bus according to claim 1, wherein at least 20% of an outer surface of the body comprises glazing.

5. The bus according to claim 1, wherein the side windows comprise an outer pane and at least one inner pane connected mechanically and sealingly to the outer pane, and wherein an area of the outer pane is larger than an area of the inner pane.

6. The bus according to claim 5, wherein, in a lower region of the side windows, the outer pane extends downwards over the at least one inner pane, and wherein an inner side of the outer pane is adhesively bonded to an outer surface of a substantially horizontally extending central chord of the metallic framework structure.

7. The bus according to claim 6, wherein an inner side, facing the passenger compartment, of the central chord comprises a layer of an aerogel material, and wherein a cladding profile is mechanically fastened to the central chord, such that the cladding profile partially engages over the layer and, on an outer side, abuts areally against the inner pane of at least one of the side windows.

8. The bus according to claim 1, further comprising a layer of an insulation material, arranged on the metallic framework structure at least in regions on a side facing the passenger compartment and/or on a side facing an opening formed by the framework structure.

9. The bus according to claim 1, wherein the body comprises a floor which comprises a base plate made of a composite product of crosslinked polymer foam and glass fibres as well as a floor covering applied on the inside.

10. The bus according to claim 1, wherein the body comprises a roof which includes the second planar elements which are arranged in openings of the metallic framework structure.

11. The bus according to claim 1, wherein the body comprises a layer of an aerogel material in the region of wheel arches.

12. The bus according to claim 11, wherein the layer of the aerogel material is arranged on an outer side, facing away from the passenger compartment, of the body, and wherein a mechanical protective layer is arranged on the outside of the insulation layer.

13. The bus according to claim 1, wherein at least one door of the bus comprises a device for generating an air curtain.

14. The bus according to claim 1, wherein the bus comprises an electric drive and a drive battery, wherein a charging connector for charging the drive battery is arranged in the region of the side windows in such a way that the charging connector is accessible from the outside through a cutout in one of the side windows.

15. The bus according to claim 8, wherein the layer of an insulation material comprises a layer of a rubber material.
